(19) United States
(12) Patent Application Publication
(10) Pub. No.: US 2012/0211485 A1
(43) Pub. Date: Aug. 23, 2012

(54) HEAT INSULATION MATERIAL FOR MICROWAVE HEATING AND METHOD FOR MANUFACTURING THE SAME

(75) Inventors: Masami TAGUCHI, Hitachi (JP); Kazutaka Okamoto, Tokai (JP)

(73) Assignee: Hitachi, Ltd.

(21) Appl. No.: 13/397,760

(22) Filed: Feb. 16, 2012

(30) Foreign Application Priority Data
Feb. 22, 2011 (JP) 2011-035299

(51) Int. Cl. H05B 6/64; C04B 35/64

(52) U.S. Cl. 219/679; 264/681

(57) ABSTRACT

A heat insulation material for microwave heating with excellent heating efficiency is provided. A heat insulation material for microwave heating includes a base material formed of an inorganic oxide, and fine carbon particles are dispersed in the heat insulation material. Preferably, the heat insulation material includes the carbon in an amount of 0.001 to 6 wt% . Preferably, the heat insulationmaterial has a density of 2 to 6 g/cm³.

### CLAIM OF PRIORITY

The present application claims priority from Japanese Patent Application JP 2011-035299 filed on Feb. 22, 2011, the content of which is hereby incorporated by reference into this application.

### FIELD OF THE INVENTION

The present invention relates to a heat insulation material for microwave heating and a method for manufacturing the same.

### BACKGROUND OF THE INVENTION

An external heating system such as heating by a heater mainly uses oxide-based alumina and silica as well as a zirconia-based material for an insulation material.

Japanese Published Unexamined Patent Application No. H11-147761 discloses an example which improves the corrosion resistance and thermal shock resistance by dispersing graphite into oxide-based ceramic in the furnace material used for steel making in particular.

Japanese Published Unexamined Patent Application No. 2004-257725 discloses a heat insulation material, as a heat insulation material for high-frequency wave widely used in recent years, which assists heating by combining silicon carbide with a mullite-based heat insulation material, magnesia, or zirconia. Japanese Published Unexamined Patent Application No. 11-228242 discloses a heat insulation material without an effect of assist in heating as a ramming material for high-frequency wave.

In recent years, what is called microwave heating has been studied, which uses microwave of 900 MHz to 30 GHz, a higher frequency than a common high frequency, as a process of heat treatment or sintering of metal powder. The microwave heating is a technique for heating an object by self-heating of the object. The heat generation behavior in the microwave heating strongly depends on the property of the object. Therefore, when heating to a desired temperature is not possible, a technique of assisting heating is adopted which uses silicon carbide excellent in absorption performance of electromagnetic waves (as disclosed in Japanese Published Unexamined Patent Application No. 11-135252).

Unfortunately, the technique in Japanese Published Unexamined Patent Application No. 11-135252, the object of which is to heat mainly ceramic materials, is not optimum for treatment of metallic materials. In general, metallic materials are inferior in absorption of microwave to ceramic materials which are dielectrics. Therefore, a heat insulation material or a heat insulation technique suitable for metallic materials is required when they are to be treated.

The object of the present invention is to provide a heat insulation material for microwave heating, being excellent in heating efficiency, and a method for manufacturing the same.

### SUMMARY OF THE INVENTION

The present invention provides a heat insulation material for microwave heating, which includes a base material formed of an inorganic oxide, and carbon dispersed in the base material .

The present invention also provides a method for manufacturing a heat insulation material for microwave heating, which includes the steps of mixing an inorganic oxide and a binder, and sintering a mixture of the inorganic oxide and the binder, wherein the binder is at least one selected from the group consisting of carboxymethylcellulose, methylcellulose, polyethylene oxide, triethanolamine, polyvinylalcohol, starch, and a polyacrylic acid compound.

According to the present invention, a heat insulation material for microwave heating can be provided, which has an excellent heating-efficiency.

### BRIEF DESCRIPTION OF THE DRAWINGS

FIG. 1A shows a heating layout of sample powder and heat insulation materials in the embodiment 1;

FIG. 1B shows a heating layout of sample powder, a conventional heat insulation material, and a SiC plate in the comparative example 1;

FIG. 2A is a temperature/output chart when a sample was heated by a multi-mode furnace in the embodiment 1;

FIG. 2B is a temperature/output chart when a sample was heated by a multi-mode furnace in the comparative example 1;

FIG. 3 shows a relation between the amount of contained carbon and the final heating temperature;

FIG. 4A shows a result of repeated heating and sintering test on the heat insulation material of the embodiment 1; and

FIG. 4B shows a result of repeated heating and sintering test on the heat insulation material of the embodiment 3.

### DETAILED DESCRIPTION OF THE PREFERRED EMBODIMENTS

The feature of the heat insulation material for microwave heating of the present invention is that the heat insulation material includes a base material formed of an inorganic oxide and fine carbon particles are dispersed in the heat insulation material.

The present invention will be described in detail below.

In heating an object by microwave, when the object has a low microwave-absorption characteristic, a material excellent in the microwave-absorption performance, such as silicon carbide (hereinafter referred to as SiC) and the like, is used in order to assist heating. However, SiC is expensive in general. Also, it is difficult to form SiC into a complicated shape conforming the object because of poor workability of SiC, making it difficult to heat the object uniformly when the object is large, made of a metallic material, and of a complicated shape.

SiC can be applied to a large object with a complicated shape by making SiC powdery and coating it inside the heat insulation material. However, it is difficult to make the coating thickness uniform, and the object may be heated non-uniformly. Further, most of energy of microwave is absorbed by SiC because of the extremely high microwave-absorption characteristic of SiC, making the self-heating effect of the object poor. This brings up a problem that the heating systemmay possibly become the same as a heating by a heater and the effect peculiar to microwave heating is weakened.

As a heat insulation material superior in heat efficiency to SiC, with a lower cost and a stronger effect of assist in heating than SiC, fine carbon particles are dispersed in a heat insulation material. Such a heat insulation material is used for high frequency heating or a heat treatment in a heating furnace for microwave, and is optimum for a heat treatment such as sintering of a metal-based material.

Examples of the base material of the heat insulation material include an oxide such as Al₂O₃, SiO₂, or ZrO₂ and a composite of these oxides. The oxide-based ceramics, such as alumina (Al₂O₃) and silica (SiO₂), are excellent in permeability of microwave of approximately 0.5 to 6 GHz oscillated from a common magnetron, and exert excellent heat insulation property by lowering the density. Further, zirconia (ZrO₂), which is expensive, is superior in microwave-absorption property to Al₂O₃ and SiO₂, and it can insulate the heat more efficiently than Al₂O₃ and SiO₂ as an insulation material for microwave, depending on conditions. In microwave heating, because the object to be heated is only the vicinity of the sample and the vicinity of the sample is rapidly heated and cooled, high heat insulation performance and high thermal shock resistance are required. The heat insulation material of Al₂O₃, SiO₂ and ZrO₂ are superior in thermal shock resistance when the density is lower to some extent.

Accordingly, it is preferable that the apparent density of these heat insulation materials is 1.5-7 g/cm³, more preferably approximately 2-6 g/cm³.

The heating efficiency of metal powder by microwave heating drops as sintering of the metal powder progresses. Therefore, it is effective to use a susceptor for assisting the heating. In the present invention, carbon component is adopted as the susceptor.

Carbon is a semiconductor, largely changes in microwave-absorption efficiency according to the particle diameter thereof, and is more easily heated as the particle diameter of carbon is finer. Accordingly, the particle diameter of carbon is preferably 0.01 μm to 100 μm. It is possible to deal with the heating temperature of up to approximately 1,600° C. by making the particle diameter of carbon 0.01 μm to 100 μm.

In a collected state, the particles of carbon electrically contact with each other, and the heating efficiency corresponding to the particle diameter cannot be sufficiently secured. Therefore, it is desirable that carbon is in a state of being uniformly dispersed in the oxide heat insulation material described above. When the amount of the carbon is too small, energy concentrates to a small amount of carbon and consumption of carbon increases. Therefore, the heat insulation material should include the carbon component of at least 0.001 wt% or more. When the amount of the carbon is excessive, energy of microwave is consumed for raising the temperature of the carbon, hampering the self-heating of the sample. Accordingly, the upper limit of the amount of the carbon is preferably 6 wt%.

In manufacturing the heat insulation material described above, uniform dispersion of the carbon component is important. In the technique of directly mixing when forming low density oxides, fine carbon particles may agglomerate, and its effect may not be exerted sufficiently. By utilizing the carbon component included in the binder of the oxide heat insulation material, fine carbon particles can be uniformly dispersed. Uniform dispersion of the fine carbon particles in the heat insulation material can be achieved by mixing the fine carbon particles, as a binder component, that is, an organic compound, with oxides of the raw material, forming the mixture, and heating the formed material to 500 to 1,200° C. in a non-oxidizing atmosphere (in vacuum, for example) to carbonize the binder component.

Examples of the obtained organic component of the binder include carboxymethylcellulose, methylcellulose, polyethylene oxide, triethanolamine, polyvinylalcohol, starch, and a polyacrylic acid compound.

Then, by including the organic compound which is the binder in a precursor by 0.01 to 10 wt%, the heat insulation material of the present invention including 0.001 to 6 wt% of the carbon component can be obtained after heating.

The heat insulation material described above is mainly applied to a microwave applicator and a microwave heating furnace. When the microwave heating furnace is used in a high vacuum atmosphere or in a high-purity inactive gas atmosphere, the heat insulation material exerts the effect of assist in heating even if the carbon of a predetermined weight and a predetermined particle diameter is in a state of only being dispersed in an oxide.

On the other hand, in a so-called oxidizing atmosphere, such as in a low vacuum atmosphere or in a low-purity inactive gas atmosphere, carbon is severely consumed to be oxidized, and therefore the heat insulation material cannot be used for a long time in a state in which carbon is only dispersed in an oxide. In order to suppress this oxidation of the carbon, it is effective to coat the heat insulation material with glass . Examples of materials of the glass include sodium silicate and potassium silicate. The heat insulation material can be glass-coated by impregnating the heat insulation material with a liquid material of the glass and by drying it. With this coating treatment, oxidation resistance can be improved and excellent durability can be secured even in the oxidizing atmosphere.

The present invention will be described in detail with reference to embodiments below.

### Embodiment 1

The present embodiment is an example in which a heat insulation material was used and metal powder is sintered, the heat insulation material being obtained by adding carbon to a heat insulation material including base material formed of alumina, or silica, or a composite thereof. The precursor was adjusted so that the amount of the carbon included in the heat insulation material was 0.5 wt%.

A groove with an outside diameter of 95 mm, an inside diameter of 75 mm, and a depth of 7 mm was machined in an insulation material plate of 150 mm×150 mm×20 mm. The groove was filled with cast iron powder of approximately 150 μm by tapping. Sample powder is the cast iron powder with average grain diameter of approximately 150 μm. The apparent density of the cast iron powder filled in the groove is approximately 3 g/mm³.

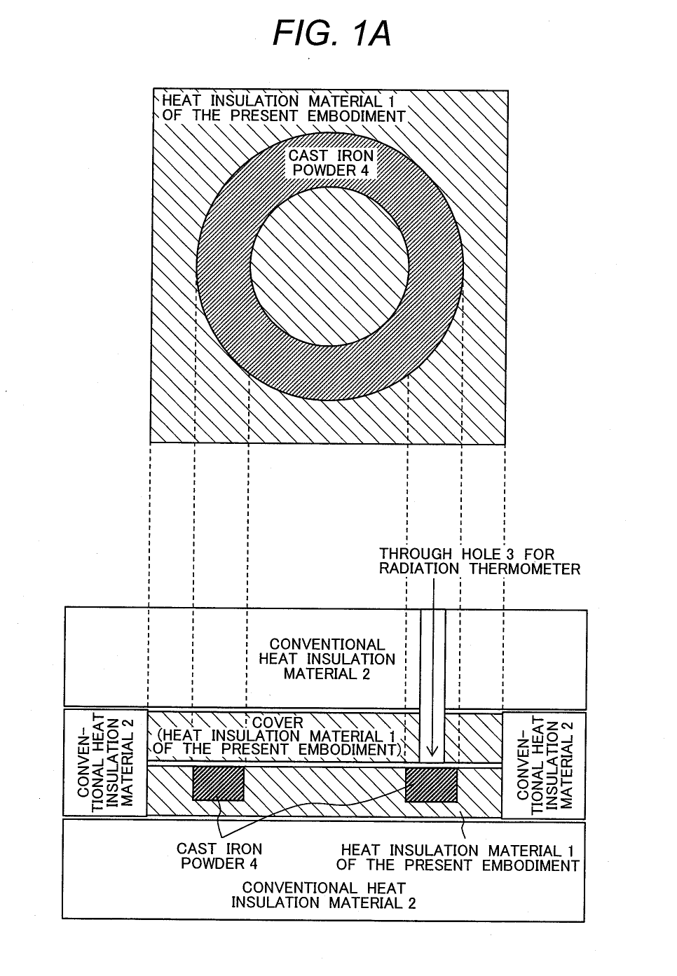

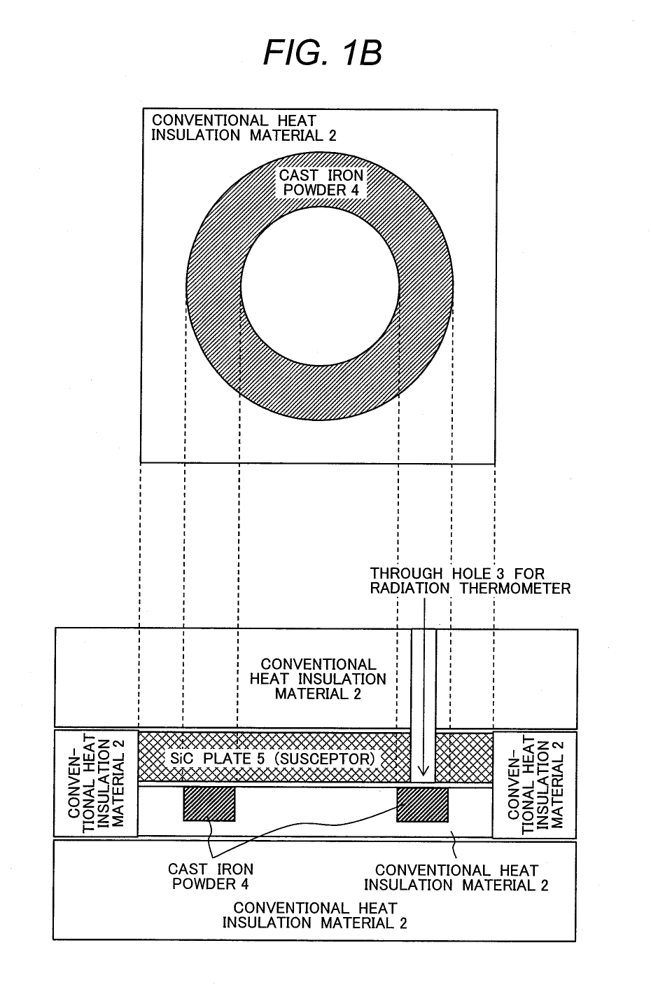

FIG. 1A shows a heating layout of sample powder and heat insulation materials in the present embodiment.

A heat insulation material 1 of the present embodiment filled with cast iron powder 4 had a plate formed of the heat insulation material 1 of the present embodiment on the top as a cover. The periphery of these heat insulation materials 1 of the present embodiment was covered with conventional heat insulation materials 2 which were formed of Al₂O₃ and SiO₂ and did not include a susceptor (carbon component). Because the temperature of the sample was measured by a radiation thermometer, a through hole 3 was arranged in the heat insulation material 1 (the cover) of the present embodiment and a conventional heat insulation material 2 in order to reserve a visual field for the radiation thermometer. Sintering was performed by a multi-mode type microwave sintering furnace of 2.45 GHz.

The sintering was performed under the condition of an atmosphere of N₂ gas and a target temperature of 1,050 to 1,060° C. The microwave output was 1 kW at the beginning and was adjusted with the upper limit of 2 kW depending on the heating situation. The temperature was measured by the radiation thermometer, and the radiation ratio was set 1.0.

### Comparative example 1

FIG. 1B shows a heating layout of sample powder, a conventional heat insulation material, and a SiC plate in the comparative example 1.

As a comparative example 1, a groove was machined similarly to the embodiment 1 in an insulation material (a conventional heat insulation material 2) which was formed of Al₂O₃ and SiO₂ and did not include a carbon component, the groove being filled with the cast iron powder 4, and sintering being performed by the microwave sintering furnace. Then, a plate made of SiC (SiC plate 5) was placed as a cover of the heat insulation material with the machined groove so as to assist heating. A through hole 3 was arranged in the SiC plate 5 and a conventional heat insulation material 2 in order to reserve a visual field for the radiation thermometer.

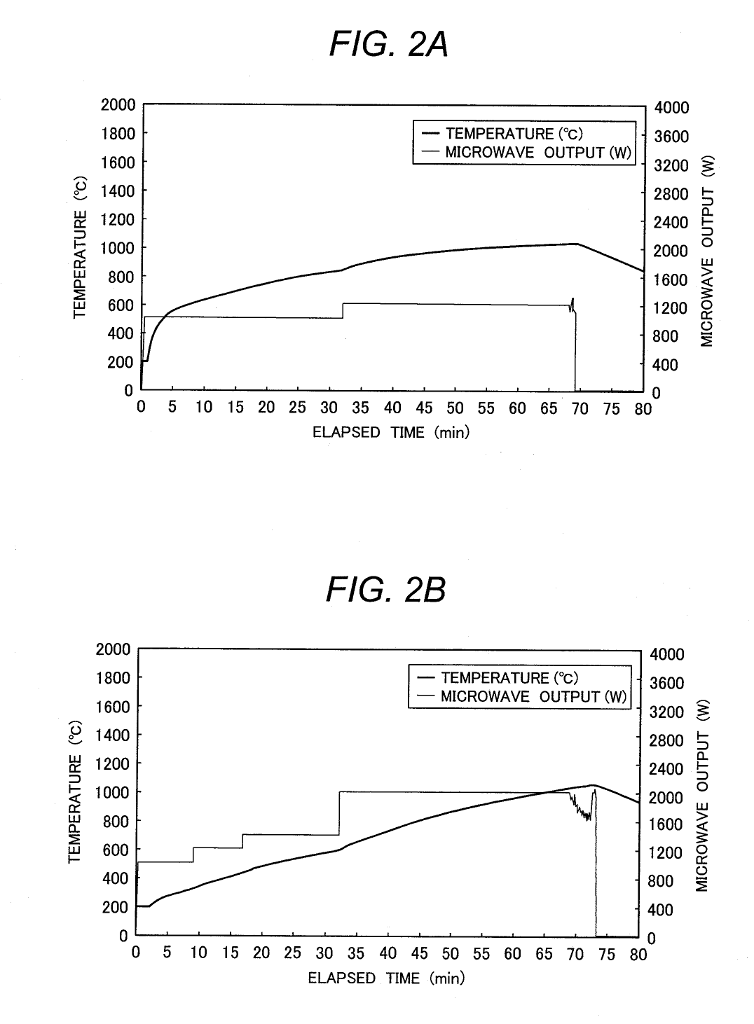

FIGS. 2A and 2B are temperature/output charts when the samples were heated by the multi-mode furnace in the embodiment 1 and in the comparative example 1, respectively.

When the heat insulation material 1 of the embodiment 1 was used, the temperature reached the target temperature with a microwave output of 1.2 kW, which exhibited excellent heating efficiency. The sample heated with the heat insulation material 1 of the embodiment 1 could be sintered with little shrinkage, almost maintaining the filling shape. The sample after heating could be sufficiently handled, and exhibited an excellent sintered state over the whole circumference of the ring.

On the other hand, in the case of the comparative example 1 (a combination of the conventional heat insulation material 2 and the SiC plate 5), the rise in temperature was slow at the initial stage of heating. The reason is that majority of the microwave output was absorbed by SiC. In addition, it took a microwave output of 2 kW to reach the target temperature. When the conventional heat insulation material 2 and the SiC plate 5 were used, sintering was insufficient over the whole circumference of the ring. In heating with the conventional heat insulation material 5 and the SiC plate 2, self-heating of the sample powder was suppressed and the heat penetrated to the sample only from the top of the sample (the surface facing the SiC plate 5) . Therefore, sintering of the powder did not progress sufficiently.

As described above, it was confirmed that the heat insulation material of the embodiment 1 exhibited superior heating efficiency to the combination of the conventional heat insulation material and the SiC plate of the comparative example 1, and that the powder could be efficiently sintered with a low output of microwave.

### Embodiment 2

The embodiment 2 is an example in which the amount of carbon contained in a heat insulation material was made 0.3 to 9 wt% by adjusting the precursor of the heat insulation material of the embodiment 1. An element test was performed to irradiate solely a heat insulation material of the embodiment 2 having a diameter of as small as approximately 10 mm with microwave. The heating was performed under the condition of a microwave output of 1 kW (multi-mode furnace) and an atmosphere of nitrogen.

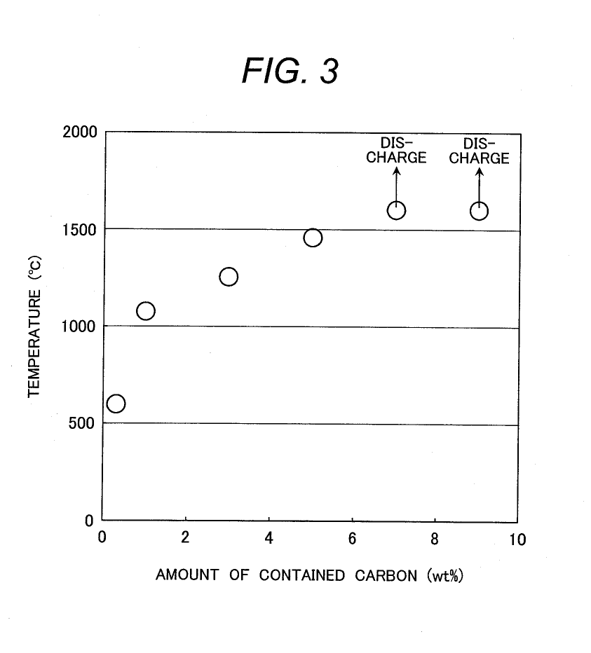

FIG. 3 shows a relation between the amount of contained carbon and the final heating temperature. When the amount of the carbon was approximately 7 wt% or more, a steep rise in temperature and a discharge accompanied by plasma were occurred.

A sintering test of the cast iron powder, similar to that in the embodiment 1, was performed using a heat insulation material including carbon in the amount of 7 wt%. As a result, the sample had portions where sintering did not progress and where melting occurred, unable to obtain a good sintered object.

### Embodiment 3

As a heat insulation material of the embodiment 3, the heat insulation material of the embodiment 1 was coated on the surface by sodium silicate. The heat insulation material of the embodiment 1 was impregnated with a mixture of sodium silicate and pure water from the surface and thereafter dried for 1 hour at approximately 100° C.

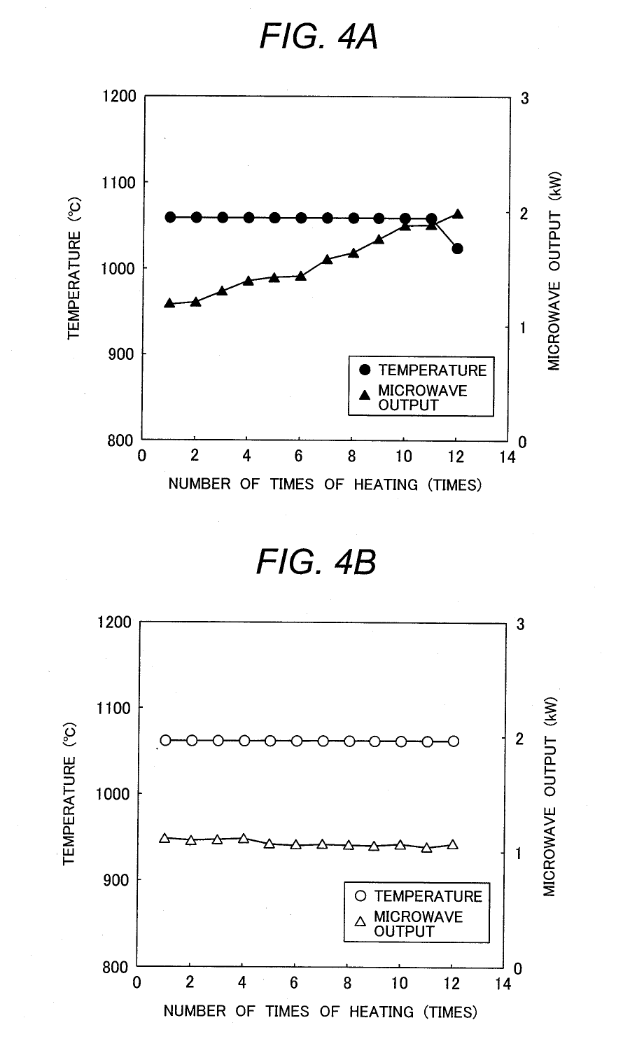

FIGS. 4A and 4B show results of repeated heating and sintering tests on the heat insulation material of the embodiment 1 (without coating) and on the heat insulation material of the embodiment 3 (with coating), respectively. The heating tests were repeated under the same condition as in the embodiment 1.

With the heat insulation material of the embodiment 1, the microwave output for reaching the target temperature (1,060° C.) increased as the number of times of heating increased. However, in the 12th heating, heating to the target temperature was not achieved even when the microwave output of 2 kW was applied. It is considered that, when the heat insulation material of the embodiment 1 was repeatedly used, the oxygen component existing in the atmosphere as an impurity and the carbon component in the heat insulation material reacted with each other, and the carbon was consumed. On the other hand, the heat insulation material of the embodiment 3, which had been coated, showed an excellent durability without a lowering of the heating efficiency even after being used 12 times. Accordingly, consumption of carbon can be suppressed by coating the surface of the heat insulation material.

In addition, it was confirmed that a similar effect was exerted when the coating material was potassium silicate. It is considered that consumption of carbon was suppressed because the glass coating was formed on the surface of the heat insulation material.

What is claimed is:

1. A heat insulation material for microwave heating, comprising:
a base material formed of an inorganic oxide; and
carbon dispersed in the base material.

2. The heat insulation material for microwave heating according to claim 1,
wherein the heat insulation material includes the carbon in an amount of 0.001 to 6 wt%.

3. The heat insulation material for microwave heating according to claim 1,
wherein the carbon is in a form of particles of 0.01 to 100 μm, and the heat insulation material has a density of 2 to 6 g/cm³.

4. The heat insulation material for microwave heating according to claim 1,
wherein the inorganic oxide includes at least one oxide selected from the group consisting of Al₂O₃, SiO₂, and ZrO₂.

5. The heat insulation material for microwave heating according to claim 1,
wherein the heat insulation material has a surface coated with oxide-based glass.

6. A microwave furnace comprising:
the heat insulation material according to claim 1,
wherein microwave used in the microwave furnace is 900 MHz to 30 GHz.

7. A microwave furnace comprising:
the heat insulation material according to claim 2,
wherein microwave used in the microwave furnace is 900 MHz to 30 GHz.

8. A microwave furnace comprising:
the heat insulation material according to claim 3,
wherein microwave used in the microwave furnace is 900 MHz to 30 GHz.

9. A microwave furnace comprising:
the heat insulation material according to claim 4,
wherein microwave used in the microwave furnace is 900 MHz to 30 GHz.

10. A microwave furnace comprising:
the heat insulation material according to claim 5,
wherein microwave used in the microwave furnace is 900 MHz to 30 GHz.

11. A method for manufacturing a heat insulation material for microwave heating, comprising the steps of:
mixing an inorganic oxide and a binder; and
sintering a mixture of the inorganic oxide and the binder;
wherein the binder is at least one selected from the group consisting of carboxymethylcellulose, methylcellulose, polyethylene oxide, triethanolamine, polyvinylalcohol, starch, and a polyacrylic acid compound.

12. The method for manufacturing a heat insulation material for microwave heating according to claim 11,
wherein the binder is mixed in an amount of 0.01 to 10 wt%.
